(19) United States
(12) Patent Application Publication
(10) Pub. No.: US 2008/0205076 A1
(43) Pub. Date: Aug. 28, 2008

(54) Automatic Dimming Liquid Crystal Mirror System

(75) Inventors: Bahman Taheri, Kent, OH (US); Yehuda Borenstein, Misgav (IL)

Correspondence Address: FENNEMORE CRAIG, 3003 NORTH CENTRAL AVENUE, SUITE 2600, PHOENIX, AZ, 85012, US

(73) Assignee: ALPHAMIRROR INC., Beachwood, OH (US)

(21) Appl. No.: 11/910,875

(22) PCT Filed: Apr. 5, 2006
(86) PCT No.: PCT/IL06/00431

§ 371 Date: Nov. 19, 2007

Related U.S. Application Data
(60) Provisional application No. 60/668,084, filed on Apr. 5, 2005.

(51) Int. Cl. B60R 1/12

(52) U.S. Cl. 362/494

(57) ABSTRACT

An automatic dimming mirror system is disclosed. The mirror system comprises a liquid crystal reflective assembly being responsive to voltage applied across the assembly, and an electronic circuitry for varying a level of the voltage at a predetermined rate thereby to a alter a reflectance level of the assembly at the predetermined rate.

### FIELD AND BACKGROUND OF THE INVENTION

The present invention relates to a dimming mirror and, more particularly, to an automatic dimming liquid crystal mirror.

Vehicles generally include an interior rearview mirror and two side exterior rearview mirrors. The rearview mirrors allow the driver to view scenes behind the vehicle without having to face in a rearward direction and to view areas around the vehicle that would otherwise be blocked by the vehicle structure. As such, rearview mirrors are an important source of information to the driver. Bright lights appearing in a scene behind the vehicle, such as from another vehicle approaching from the rear, may create glare in a rearview mirror that can temporarily visually impair or dazzle the operator. This problem is only aggravated under low ambient light conditions such as at night, when the eyes of the driver have adjusted to the darkness.

Various solutions have evolved to deal with the problem of glare in rearview mirrors of vehicles. One conventional solution to this problem, used primarily with interior, center-mounted rear view mirrors, is to employ a prismatic mirror with a switch lever on the mirror housing.

The switch can be manually moved between a daytime position, providing direct, normal intensity reflection from the mirror surface, and a nighttime position providing a reduced intensity reflection. When the driver experiences glare, he manually changes the rearview mirror setting to low reflectivity. With the low intensity of light reflected to the driver, the intensity of reflected headlights from trailing vehicles is insufficient to impair the driver's vision. Once the glare is subsided the driver can manually switch the rearview mirror back to high reflectivity. Difficulties with manually controlled mirrors include the glare experienced before the mirror could be switched as well as driver distraction caused by finding and operating the switch lever.

Also known in the art are automatically dimming rearview mirrors which eliminate the need for the operator to manually switch the mirror.

Early designs of such automatically dimming mirrors included a single glare sensor facing rearward to detect the level of light striking the mirror. This design, however, has been proved to be inadequate since the threshold perceived by the driver for dimming the mirror, known as the glare threshold, varied as a function of the ambient light level. An improved design is a dual sensor automatically dimming mirror which includes a second light sensor for detecting the ambient light level. The glare threshold in these systems is based on the amount of ambient light detected. Another related approach includes an imaging array which gathers light from behind and beside the vehicle. Ambient light is detected by examining pixels generally looking sideways. The cost of such systems is, however, prohibitively expensive for many automotive applications.

Improvements in glare reduction additionally occurred when prismatic mirrors having two states were replaced with multi-state mirrors which include dimming elements capable of providing many levels of reflectivity reduction. One type of such multi-state automatically dimming rearview mirrors is based on the well known Stark effect, named after the German physicist and Nobelist Johannes Stark (1874-1957). According to the Stark effect, there is a splitting or shift of the spectral lines of atoms when present in an external electric field. The Stark effect is also referred to in the literature as the electrochromic effect and the automatically dimming rearview mirrors are commonly termed electrochromic mirrors.

An electrochromic mirror includes an electrochromic medium connected between two electrodes. Under the principles of the Stark effect, the electrochromic medium is responsive to external electric field generated by electrodes. When a sufficient electrical potential difference is applied across the electrodes of the automatically dimming rearview mirror the electrochromic medium enters a translucent state by changing its spectral characteristics. Typical electrochromic mirrors are described in many U.S. patents (to this end see, U.S. Pat. Nos. 4,902,108, 5,724,187, 5,679,283, 5,725,809).

Prior art electrochromic mirror suffer from many limitation such as slow response rate, and high cost.

Other known automatically dimming mirrors make use of the properties of liquid crystals which are normally transparent to light but which when subjected to an electric field beyond a certain threshold, present a state of molecular realignment which is visibly different from the normal transparent state. While being in the molecular realignment state the light reflected from the mirrors is attenuated to a degree which is proportional to the applied electric field. Upon suppressing the applied electric field, the liquid crystal returns to the normal transparent state. Using such mirrors, therefore, it is possible to obtain selectively a high or a low reflecting power, according to whether the electrical voltage applied to the liquid crystal is lower or greater than the threshold.

Typical automatically dimming liquid crystal mirrors are found, e.g., in U.S. Pat. Nos. 4,660,937, 4,589,735 and 4,200,361. These and other prior art liquid crystal mirrors are costly, technologically difficult to employ, or otherwise suffer from poor performances.

Also known in the art are “clip-on” panoramic mirrors that are mounted with ease over the existing original mirror. This might be done, for example, using a springy mechanism such as a formed Leaf Springy (at times supplied with fastening screws). The driver benefits by its wider—panoramic rear view performance. A marked advantage of such a mirror is its simple and easy mode for installation upon the existing original mirror, as well as easily dismantling it if desired. An inherent disadvantage of these panoramic mirrors stem from the fact that due to the springiness of the attachment, a phenomena of their being dislodged in case of an accident—thus endangering the driver or the passengers.

At the same time, mirrors—that as said are installable—but using different fastening means, are also available, wherein the fastening mechanism employs a clasp (or band)—one or more wound around the two mirrors, and thus tightens the added mirror to the existing one. This means is considered less vulnerable in case of an accident, and keeps the added mirror well in place. However, the disadvantage of this fastening method is due to the fact that there exist no damping action associated with it, and thus—the vibrations, in many cases, renders the image in the mirror to be unstable. In many cases, the surface areas (fastened one to the other by the clasps) are not compatible and when traveling the added on mirror is prone to undergo vibrations.

The present invention provides solutions to the problems associated with prior art automatic dimming techniques.

### SUMMARY OF THE INVENTION

According to one aspect of the present invention there is provided an automatic dimming mirror system. The automatic dimming mirror system comprises a liquid crystal reflective assembly being responsive to voltage applied across the assembly, and an electronic circuitry for varying a level of the voltage at a predetermined rate thereby to a alter a reflectance level of the assembly at the predetermined rate.

According to further features in preferred embodiments of the invention described below, the electronic circuitry is designed and configured to receive ambient light information and rear light information, and to select the level of the voltage and the predetermined rate based on the ambient light information, the rear light information or a combination thereof.

According to still further features in the described preferred embodiments the system further comprises an ambient light sensor for collecting and transmitting the ambient light information to the electronic circuitry, and a rear light sensor for collecting and transmitting the rear light information to the electronic circuitry.

According to still further features in the described preferred embodiments the system further comprises a user interface communicating with the electronic circuitry.

According to still further features in the described preferred embodiments the electronic circuitry is designed and configured to receive from the user interface characteristic response information of a user to light and to weight the predetermined rate based on the characteristic response information.

According to still further features in the described preferred embodiments the electronic circuitry is designed and configured to vary the level of the voltage at a continuous or step-wise varying rate.

According to still further features in the described preferred embodiments the system serves as a rearview mirror of a vehicle. According to still further features in the described preferred embodiments the system serves as an interior rearview mirror of a vehicle. According to still further features in the described preferred embodiments the system serves as an exterior rearview mirror of a vehicle.

According to another aspect of the present invention there is provided a method of dimming light reflected from a mirror, the method comprising applying a variable level voltage across a liquid crystal reflective assembly so as to alter a reflectance level of the liquid crystal reflective assembly, wherein the variable level voltage is varied at a predetermined rate.

According to further features in preferred embodiments of the invention described below, the method further comprises receiving ambient light information and rear light information, and selecting the level of the voltage and the predetermined rate based on the ambient light information, the rear light information or a combination thereof.

According to still further features in the described preferred embodiments the method further comprises sensing the ambient light information using an ambient light sensor, and sensing the rear light information using a rear light sensor.

According to still further features in the described preferred embodiments the ambient and/or rear light information comprises light illuminance information. According to still further features in the described preferred embodiments the ambient and/or rear light information comprises light brightness information. According to still further features in the described preferred embodiments the ambient and/or rear light information comprises light spectral information.

According to still further features in the described preferred embodiments the method further comprises receiving a characteristic response information of a user to light and weighting the predetermined rate based on the characteristic response information.

According to still further features in the described preferred embodiments the predetermined rate is selected from a set of discrete rates, each rate of the set of discrete rates corresponding to a different ambient and/or rear light condition.

According to still further features in the described preferred embodiments each rate of the set of discrete rates corresponds to a different illuminance range of the ambient and/or rear light.

According to still further features in the described preferred embodiments each rate of the set of discrete rates corresponds to a different brightness range of the ambient and/or rear light.

According to still further features in the described preferred embodiments the predetermined rate is a monotonic decreasing function of an illuminance of the ambient and/or rear light.

According to still further features in the described preferred embodiments the predetermined rate is a monotonic decreasing function of a brightness of the ambient and/or rear light.

According to still further features in the described preferred embodiments the application of the variable level voltage across the liquid crystal reflective assembly is done at a continuous or step-wise varying rate.

The present invention successfully addresses the shortcomings of the presently known configurations by providing an automatic dimming liquid crystal mirror system enjoying properties far exceeding the prior art.

According to still further features in the described preferred embodiments the mirror is an add-on automatic, self-dimming crystal mirror. Auxiliary internal mirrors of vehicles that are marketed as an option, constituting an add-on installable accessory in vehicles already in use—sold by vehicles' after market stores.

According to still further features in the described preferred embodiments the present invention constitutes a vehicle's mirror with an added capability to perform automatic self dimming when required—not depending on the vehicles power supply system and hence no “messy or clumsy” wiring required because the invention includes an autonomous mode of receiving the electric power it needs.

In its preferred configuration, the current invention constitutes a mirror that is added in the car, having an improved installation mechanism so that it damping the vibration and provides a stable image when in motion, combined with an improved method for mounting it—so that it reduces the danger of it being torn apart from its mounted position in case of an accident.

In another preferred and additional configuration, the present invention is embodied so that it constituted a mirror for a vehicle having a colored pigmentation highly discernable by the eye that is established by the color of the liquid crystal implemented and serving in its (auto) self-dimming mechanism.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an automatic dimming mirror system, according to various exemplary embodiments of the present invention;

FIG. 2 is a schematic block diagram of a liquid crystal reflective assembly, according to various exemplary embodiments of the present invention;

FIG. 3 shows a typical brightness curve as perceived by the physiological visual system from a reflective surface illuminated by constant illuminance, as a function of the reflectance of the surface;

FIG. 4 is a flowchart diagram of a method suitable for dimming light reflected from a mirror, according to various exemplary embodiments of the invention; and

FIG. 5 is a diagram representing the variation rate of the mirror system of a according to a preferred embodiment of the present invention, for different ambient light conditions.

FIGS. 6a-6e constitutes schematic illustrations of two examples of a power wise autonomous automatic self-dimming liquid crystal mirror in accordance with the invention that is the subject matter of the present application.

### DESCRIPTION OF THE PREFERRED EMBODIMENTS

The present invention is of a system and method which can be used to dim light. Specifically, the present invention can be used to reduce disability glare and/or discomfort glare in vehicles rearview mirrors.

The principles and operation of a system and method according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

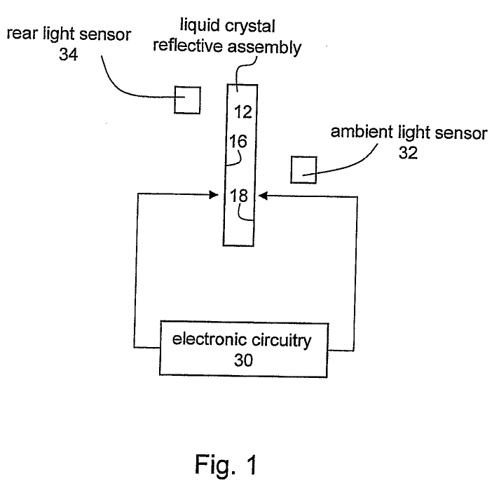

Referring now to the drawings, FIG. 1 illustrates an automatic dimming mirror system 10, according to various exemplary embodiments of the present invention. Mirror system 10 can be used, for example, as an interior or exterior rearview mirror of a vehicle.

Mirror system 10 preferably comprises a liquid crystal reflective assembly 12 with a variable reflectivity. Liquid crystal reflective assemblies are known in the art and typically operate in a similar manner to liquid crystal displays. Such liquid crystal reflective assemblies are found, e.g., in U.S. Pat. Nos. 5,841,496, 6,144,430, 6,717,639 and 6,784,956.

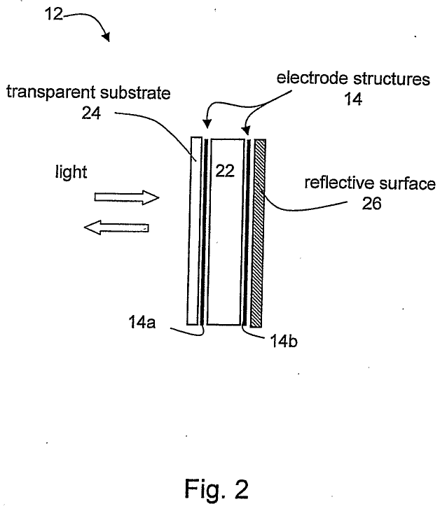

For example, in one embodiment, schematically illustrated in FIG. 2, assembly 12 comprises a liquid crystal medium 22 held between a transparent substrate 24 and a reflective surface 26.

Liquid crystal medium 22 serves as a variable transmissive element with several operation modes, each characterized by a different transmittance coefficient. Assembly 12 further comprises an arrangement of electrode structures 14 for applying voltage across liquid crystal medium 22 thereby to vary its transmittance coefficient. When medium 22 is in a transmissive mode (transmittance coefficient close to or equal unity), light, impinging on transparent substrate 24 is reflected from reflective surface 26 substantially with minimal interacting with medium 22. When medium 22 is in one of its translucent modes (transmittance coefficient is significantly lower than unity, e.g., 0.6 or lower), only a fraction of light energy impinging on substrate 24 arrives at surface 26, and only a fraction of light energy reflected from the surface 26 exits through the substrate 24. The overall reflectance of assembly 12 varies according to the state of the liquid crystal medium. A reduction of the reflectance of assembly 12 is perceived by the viewer the dimming of mirror system 10, while an increment of the reflectance is perceived by the viewer as clearance of mirror system 10.

Assembly 12 is thus responsive to voltage, in that voltage applied across the assembly makes the liquid crystal medium translucent to a degree which depends on the level of voltage. In other words different applied voltage levels result in different reflectance levels of assembly 12. In various exemplary embodiments of the invention the arrangement of electrode structures comprises two electrode structures, 14a and 14b, respectively disposed on or close to front side 16 and a back side 18 of assembly 12. Depending on the shape of medium 22, electrode structures 14 can be planar or have a certain degree of curvature. One or more of electrode structures 14 is preferably made of a light transmissive material, such as, but not limited to, indium-tin-oxide and a composite thereof.

Electrode structure 14b, which is deposed on back side 18 of assembly 12 can be made semi-transmissive, non-transmissive or reflective as desired. For example, in one embodiment, electrode structure 14b preferably serves as a reflective layer thus can substitute substrate 26 of assembly 12. In this embodiment, electrode structure 14b can utilize a metallic material having both high reflectivity and high electrical conductivity. Representative materials for such metallic material include, without limitation, silver or silver alloy such as silver-gold alloy, silver-platinum alloy, silver-palladium alloy and the like. Conversely, electrode structure 14a is preferably light transmissive hence can substitute transparent substrate 24 of assembly 12.

Mirror system 10 further comprises an electronic circuitry 30 for varying a level of the voltage applied on assembly 12. Circuitry 30 also controls the rate at which the voltage is varied. In various exemplary embodiments of the invention circuitry 30 receives ambient light information and rear light information, and selects both the level of the voltage and its variation rate based on the ambient light information, the rear light information or a combination thereof. This can be achieved, for example, by incorporating a microprocessor in circuitry 30 and supplementing the microprocessor with a suitable algorithm which processes the light information and determines the desired level and variation rate of the voltage.

The light information is preferably collected and transmitted to circuitry 30 by an arrangement of light sensors. Thus, according to a preferred embodiment of the present invention mirror system 10 comprises an ambient light sensor 32 and a rear light sensor 34. Ambient light sensor 32 collects ambient light information from the environment and transmits the information to circuitry 30, substantially in real time.

As used herein “ambient light” refers to any light propagating in the environment, irrespectively whether said light impinges or not on mirror system 10. Preferably, the ambient light includes at least one light ray which does not have the potential to be reflected from assembly 12. In other words, the ambient light includes at least one light ray which does not impinge of side 16 of assembly 12.

Several ambient light sensors can be employed for more accurate measurement of light characteristics. The ambient light sensor(s) can be mounted on the body of mirror system 10 or be placed in other nearby locations. For example, when mirror system 10 is a rearview mirror of a vehicle, the ambient light sensors can be mounted on selected parts of the vehicle, such as, but not limited to, the dashboard, side doors, glove compartment or engine hood of the vehicle. Circuitry 30 can also collect information from ambient light sensors mounted on other mirror systems of the same vehicle. Thus, when the vehicle has a one interior mirror system and two exterior mirror systems, the electronic circuitry of each mirror system can collect ambient light information from ambient light sensors of each and all mirror systems.

Rear light sensor 34 collects rear light information and transmits the information to circuitry 30 also substantially in real time.

As used herein “rear light” refers to light which can potentially be reflected from assembly 12. Thus, the rear light includes one or more light rays impinging on side 16 of assembly 12. Typically, the rear light is originated from a bright or high intensity light source emitting light rays in the direction of mirror system 10 and generating a glare. Such glare can be generated by the headlights of a vehicle or another artificial light source. Glare can also be generated by direct sunlight (e.g., when the sun is close to the horizon).

Rear light sensor 34 is preferable mounted on or close to side 16 of assembly 12 so as to minimize sensation of undesired light rays. Nevertheless, even when ambient light rays are sensed by rear light sensor 34, the contribution of such sensation can be determined by the microprocessor of circuitry 30 which can be programmed to identify rapid changes of light characteristics (illuminance, brightness, hue, saturation) as rear light while rejecting other signals. Additionally or alternatively, the detection threshold of rear light sensor 34 can be selected such that ambient light is not detected thereby.

Many types of light sensors are contemplated. Preferably, both ambient 32 and rear 34 light sensors operate within the typical ranges of temperature, humidity, shock and vibration experienced within or on the exterior of a vehicle's passenger compartment.

In one preferred embodiment, the light sensors are cadmium sulfide cells, which exhibiting increasing conductance with increasing light levels. Cadmium sulfide cells are known in the art and are found, e.g., in U.S. Pat. Nos. 4,086,101, 4,159,914 and 4,287,383, the contents of which are hereby incorporated by reference.

In another preferred embodiment, the light sensors are photodiodes, e.g., discrete photodiodes. Photodiodes are known in the art and are found, e.g., in U.S. Pat. Nos. 5,059,809, 5,117,118 and 5,936,231 the contents of which are hereby incorporated by reference.

In an additional preferred embodiment, the light sensors are integrated silicon chips incorporating a silicon-based light transducer and conditioning electronics. The chips generate charge at a rate proportional to the amount of incident light. The charge is collected over an integration period and the resulting potential indicates the level of light to which the sensor is exposed over the integration period. Suitable integrated silicon chips are found, for example, in U.S. Pat. Nos. 4,916,307, 5,214,274, 5,243,215, 5,338,691 and 5,789,737 the contents of which are hereby incorporated by reference.

When mirror system 10 is used as one of a vehicle's rearview mirrors. The driver uses mirror system 10 to view a rearward scene. Most of the time, the driver is looking forward through the windshield of the vehicle. The eyes of the driver therefore adjust to the ambient light coming from a generally forward direction. A relatively bright light source (e.g., from another vehicle or direct sunlight) in a rearward scene may produce light which can be reflected from mirror system 10 (either when serving as an interior rearview mirror or an exterior rearview mirror) to produce glare and temporarily visually impair, distract or dazzle the driver.

Ambient light sensor 32 senses the environmental light, preferably from a generally forward direction, and produces a signal (discrete or analog) indicating the amount of ambient light impinging on sensor 32. Similarly, rear light sensor 34 senses the rear light or glare from generally behind the vehicle, and produces a signal (again, discrete or analog) indicating the amount of rear light or glare.

To reduce the impact of the glare on the driver, the reflectance of liquid crystal reflective assembly 12 is preferably reduced by circuitry 30. Circuitry 30 receives the signals from the light sensors and controls the voltage across assembly 12. Specifically circuitry 30 selects the voltage and varies it at a predetermined rate, which rate is adapted to the light information. The light information can include any light characteristic including, without limitation, illuminance, brightness and/or spectrum.

As will be appreciated by one ordinarily skilled in the art, the brightness of the light is a measure of the light adjusted for the wavelength response of the human eye, so as to correspond to the subjective sensation of light by the physiological visual system. The illuminance of the light, on the other hand, can be defined as the power of light (integrated over the spectrum) per unit area. In SI units, the illuminance is expressed in units of lux.

The variation rate is preferably a decreasing function of the illuminance or brightness of the ambient and/or rear light. For example, for low ambient light (e.g., at night with minimal or no light sources) the variation rate is preferably high, and for high ambient light (e.g., at twilight or when the road is illuminated by street lights) the variation rate is preferably low. Additionally, the variation rate can be selected in accordance with a combination (e.g., a linear combination) of the ambient light and the rear light. Representative of such combination is, without limitation, a difference between the rear light and ambient light characteristics.

While the embodiments below are described with a particular emphasis to ambient light, it is to be understood that more detailed reference to ambient light is not to be interpreted as limiting the scope of the invention in any way. Specifically, any reference below to ambient light in conjunction to variation rate can be applied is to rear light or a suitable combination of ambient and rear light.

The advantage of using a variation rate which is a decreasing function of the brightness of the ambient light is that such rate mimics the response of the physiological visual system to light.

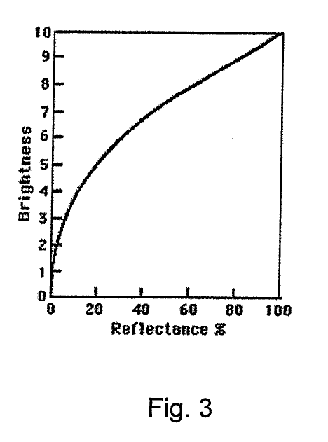

FIG. 3 shows a typical brightness curve as perceived by the physiological visual system from a reflective surface illuminated by constant illuminance, as a function of the reflectance of the surface. In FIG. 3 the brightness is expressed in arbitrary units from 0 to 10 and the reflectance is expressed as percentage of the incident light energy. As shown in FIG. 3, the perceived brightness is not linearly proportional to the reflectance. There is an approximate logarithmic relationship between the lumens reflected from a reflective surface (or emitted by a light source). For example, for each doubling of the reflectance the perceived brightness is increased by about 1.5 units on the brightness scale.

As the derivative of a logarithmic function is inversely proportional to the argument of the function, the rate of change of perceived brightness is inversely proportional to the reflectance of the reflective surface. Thus, by changing the reflectance level of assembly 12 at a rate which is a decreasing function of the ambient illuminance or brightness, the present embodiments successfully mimic the response of the physiological visual system to light. It will be appreciated that such mimicry significantly improves the driver's comfort and reduces distraction resulting from the appearance of glare or unadjusted reduction of reflectance of the mirror.

The variation rate can be any decreasing function of the illuminance or brightness. For example, in one preferred embodiment, the variation rate is selected from a set of discrete rates, where each rate corresponds to a different illuminance or brightness. In another preferred embodiment, the variation rate is a monotonic function of the illuminance or brightness, such as, but not limited to, a reciprocal function or an exponentially decaying function.

The voltage across liquid crystal reflective assembly 12 can be varied either at a constant rate or at a time-dependent rate. In any event the rate is preferably, as stated, adapted to rear and ambient light characteristics. When a time-dependent variation rate is employed, either a continuous or step-wise time dependence can be employed. For example the variation rate can be gradually increased from very small variation to the appropriate level which is adapted to the ambient light conditions.

Circuitry 30 can also receive characteristic response information of the driver from a user interface and to use this information for weighting the appropriate variation rate. If desired, circuitry 30 can also use the characteristic response of the driver to select threshold values and/or corresponding reflectance levels of mirror system 10. Alternatively or additionally, the user can further adjust the threshold values and/or corresponding reflectance levels, to achieve optimal comfort.

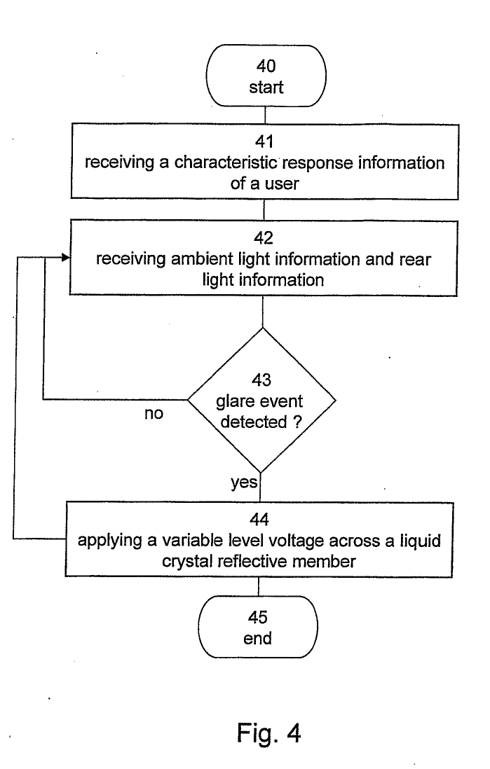

Reference is now made to FIG. 4, which is a flowchart diagram of a method suitable for dimming light reflected from a mirror, according to various exemplary embodiments of the invention. The method begins at step 40 and, optionally and preferably continues to step 41 in which characteristic response information of the user is received. The method preferably continues to step 42 in which ambient and rear light information is received (e.g., from light sensors 32 and 34). The method proceeds to decision step 43 in which the method determines whether or not a glare event was occurred. This can be done by determining if the luminance of the rear light or the luminance difference between the rare and ambient light is above a predetermined threshold. Upon an identification of a glare event, the method continues to step 44 in which the voltage on a liquid crystal reflective assembly (e.g., assembly 12) is varied at a predetermined rate as further detailed hereinabove. The method can loop back to step 42 and repeat steps 42, 43 and 44 a plurality of times. The method ends, when desired, at step 45.

It is expected that during the life of this patent many relevant liquid crystal materials will be developed and the scope of the term liquid crystal reflective assembly is intended to include all such new technologies a priori.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non-limiting fashion.

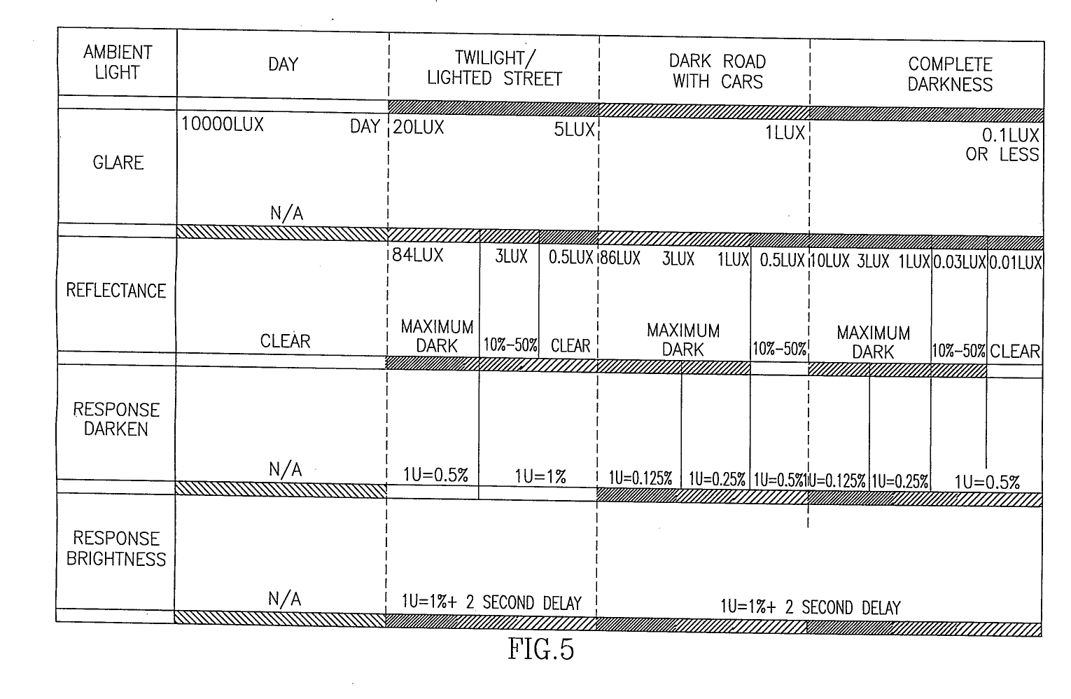

FIG. 5 is a diagram representing the variation rate of mirror system 10 for different ambient light conditions, according to a preferred embodiment of the present invention. Four discrete ambient light sectors are defined in the representative examples shown in FIG. 5. These light sectors appear on the top row of the diagram and are defined as follows: daylight (illuminance of about 20-10000 lux), twilight or light street illumination (about 5-20 lux), dark road with cars (about 1-5 lux), and complete darkness (less than about 1 lux).

The term “about”, as used thought the specification refers to ±10%.

The glare is shown in the second row of FIG. 5, for each ambient light sector. For example, for the twilight or light street illumination, three glare sectors are defined: (i) 2-86 lux, (ii) 0.5-2 lux, and (iii) below 2 lux.

The desired reflectance level of mirror 12 is shown in the third row of FIG. 5, for each ambient light sector and for each glare sector. Reflectance level designated “clear” represents a situation in which the mirror system is not dimmed. “Clear” reflectance can be, without limitation, about or above 50% reflectance level.

Referring, for example, to the twilight or light street illumination, the desired reflectance level is: less than 10% (e.g., about 5%) for the first glare sector, from 10% to 50% in the second glare sector, and clear in the third glare sector.

The variation rates for dimming mirror system 10 are shown in the fourth row and the variation rates for restoring the clear mode (or the mode immediately before to the glare event) are shown in the fifth row.

The variation rates are expressed as combinations of time (seconds) and nonlinear reflectance-variation units, denoted in FIG. 5 and hereinafter by U. The nonlinear reflectance-variation are defined as follows: when the reflectance level of mirror 12 is about 50% a single reflectance-variation unit, U, corresponds to an reduction of the reflectance from about 50% to about 38%, when the reflectance level is about 38% a single unit corresponds to a reflectance reduction from about 38% to about 25%; when the reflectance level is about 25% a single unit corresponds to a reduction from about 25% to about 16%; when the reflectance is about 16% a single unit corresponds to a reduction from about 16% to about 10%; and when the reflectance level is about 10% a single unit corresponds to a reduction of the reflectance from about 10% to about 5%.

Referring, for example, to the fourth row of FIG. 5, in the twilight ambient light sector, upon a detection of a glare event of 2-86 lux, mirror system 10 preferably reduces its reflectance at a rate of one unit per 0.5 second. According to the above definitions of the absorption-variation unit, U, such rate corresponds to total dimming time of about 2.5 seconds as follows: (i) from t=0 to t=0.5 second, reduce reflectance to 38%, (ii) from t=0.5 second to t=1 second, reduce reflectance to 25%, (iii) from t=1 second to t=1.5 seconds, reduce reflectance to 16%, (iv) from t=1.5 seconds to t=2 seconds, reduce reflectance to 10%, and (v) from t=2 seconds to t=2.5 seconds, reduce reflectance to the desired level of 5%.

Similarly, upon a detection of a glare event of below 2 lux in the twilight ambient light sector, the reflectance is reduced at a rate of one unit per 1 second, corresponding to total dimming time of about 4 seconds (from t=0 to t=1 reduce the reflectance to 38%, from t=1 to t=2 reduce to 25%, from t=2 to t=3 reduce to 16%, and from t=3 to t=4 reduce the reflectance to 10%).

According to a preferred embodiment of the present invention the restoration of the reflectance (see the fifth row of FIG. 5) is done after a delay of about 2 seconds. Preferably, the restoration is performed at a rate of 1 unit per second, irrespectively of the ambient light.

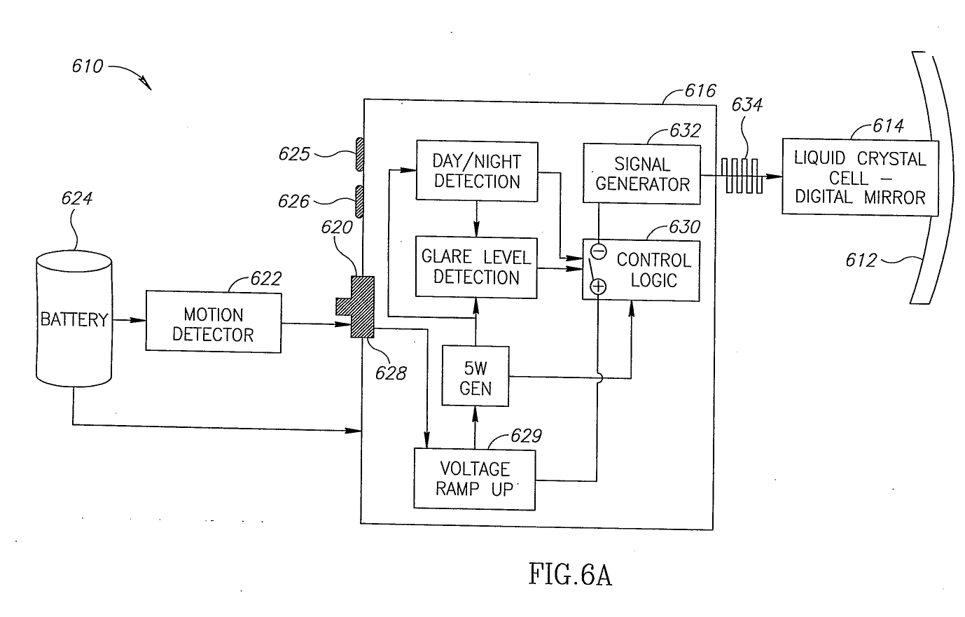

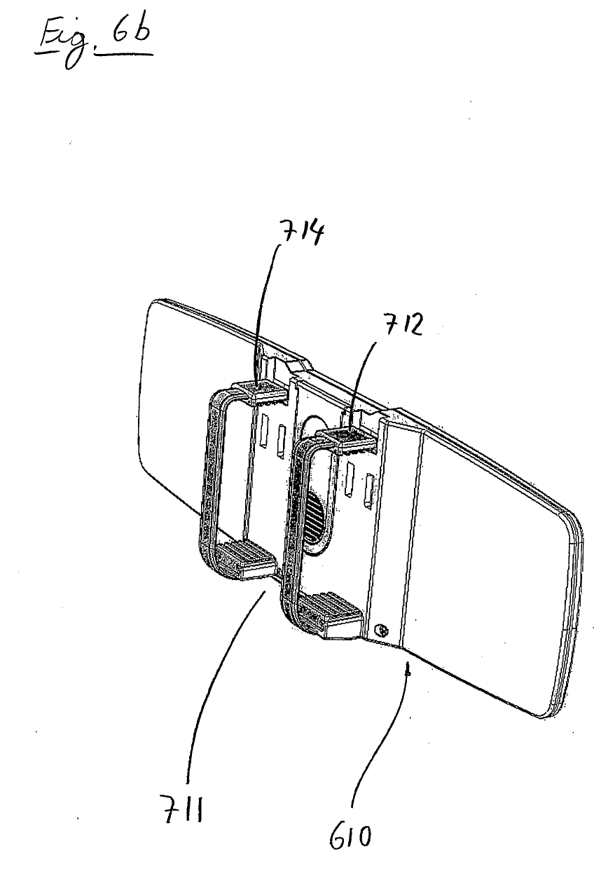

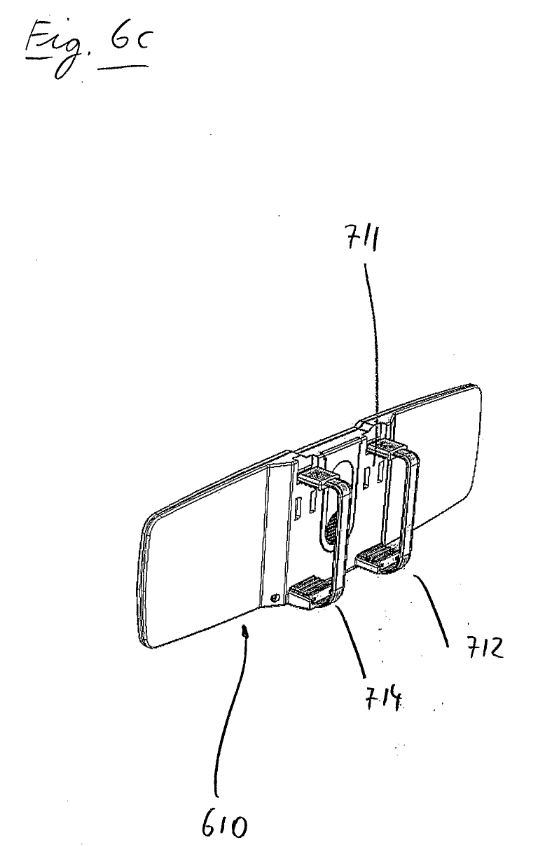

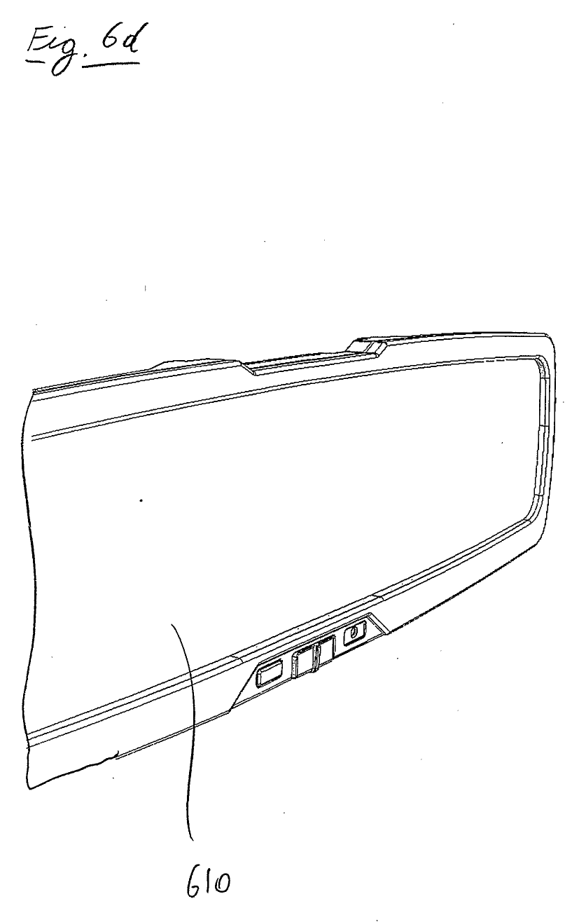

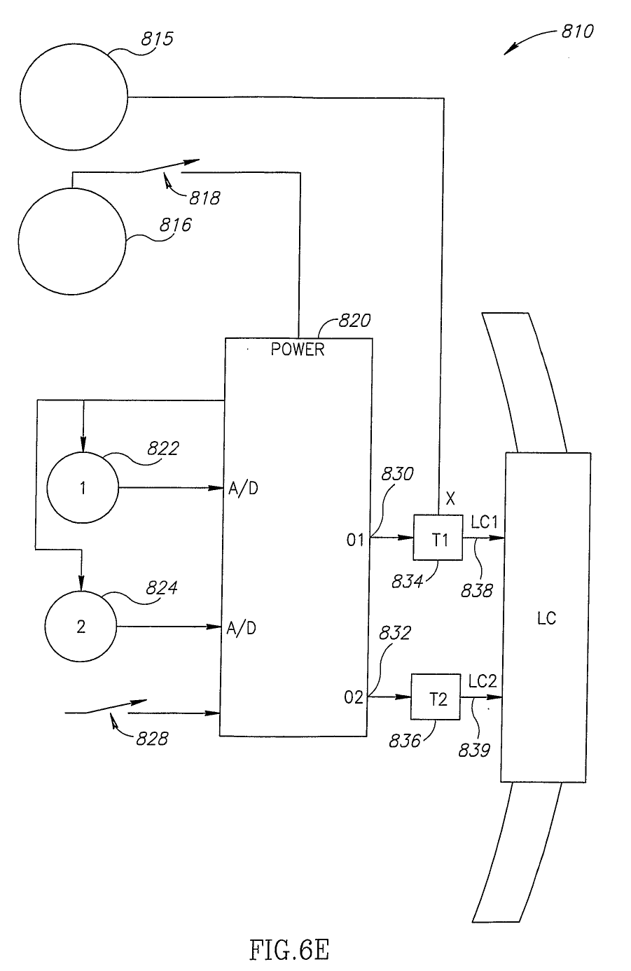

Let's refer to FIG. 6a. FIG. 6a constitutes a schematic illustration an automatic self-dimming liquid crystal mirror 610 which is power wise autonomous and marketed as an add-on mirror to be placed on existing internal mirror in the car.

Mirror 610 comprises dimming mirror 612 that includes liquid crystal cell digital mirror 614 and a sensors array 616 serving to establish the degree level of the darkening of the mirror. Mirror 610 includes in addition, an electronic control circuit board 618 that is connected to the mirror dimming assembly 612 and controls its operation.

A sorter switch of the operational states 620 is connected to assembly 612 and actually determines the manner of actuating assembly 612.

A mirror in accordance with the present embodiment is characterized by that that it includes in addition, a movement sensing assembly 622 that is connected to circuit 618 and a dry cell battery 624 that on its part is connected to movement sensing assembly 622 and to circuit 618.

Switch 620 renders the person using mirror 620 the possibility to fix three different operating states—pause (stoppage); activating—to the maximal dark level of mirror 612 and automatic state in which the darkness level of mirror assembly 612 is set by the sensors array 616.

In the illustrated example, sensors array 616 includes two sensors (625 and 626) in order to sense the illumination levels prevailing in two directions and fixing the level of darkening of mirror assembly 612 in accordance with these levels. Movement sensing assembly 622 provides indications as to the absence of movement in order to transfer mirror assembly 612 to the paused state after a certain time interval elapsed, this time interval having a pre-set value—it is the time interval during which the movement sensing assembly 622 did not detect any movement.

Movement sensing assembly 622 provides indications relating to movements in order to transfer the mirror assembly 612 over to the automatic state in which the level of darkening of the mirror assembly 612 is fixed by the sensors array 616, immediately upon sensing some movement.

In mirror 610 the power consumption of the crystalline liquid cell might be essentially smaller (to a high degree) than the power consumption of an automatic darkening mirror based on chemical ingredients (For example 1 mAmp vs 120 mAmp).

Hence, and in accordance with this example, it is feasible to use a dry cell type battery 624 (for example, a lithium battery) as the energy source for the mirror assembly 612 instead of having to use the electricity system of the car in which the mirror is installed, and its wiring.

Any professional experienced in this field would understand that the feasibility of using a dry cell type battery, without having to resort to using the vehicle's wiring to the vehicle's power system for the mirror, renders this implementation to be highly attractive for using a mirror as per the invention, wherein it is also in addition amenable to be mounted as an add-on item over the existing vehicle's original internal rear view mirror, thus providing the driver with the advantages of automatic dimming and darkening of the mirror in case of being blinded by glare from behind.

On the other hand, because a dry cell is to be used instead of getting connected to the vehicles electricity system, a mirror as per the example of the invention requires a dedicated system for controlling its operation, because otherwise it may loose its energy very soon.

Hence, and in accordance with the implementation example 610 of the invention, a motion sensing assembly 622 is introduced. In cases where no motion is taking place for a preset selectable period (for example—ten minutes)—to be specific: the vehicle in which the referred to mirror is installed did not move from its position during this period, mirror 610 would automatically switch over to a non operating mode. However, as soon as the motion sensing assembly 622 would detect a movement—it would generate an indication of its occurrence that would immediately switch the mirror over to its operating mode.

Any experienced professional would understand that this kind of a motion sensing assembly 622 might be implemented, for example, by off the shelf acceleration transducers, or alternatively just by connecting into the vehicles' odometer, or the like. Such a motion sensing assembly 622 is amenable to be packaged into within mirror 610 and the indications would be transmitted to circuit 618 that control the mirror's operation (including to actuating circuit 618 to switch over, when appropriate, to the desired power down procedure).

An “operation states selector” switch 620 is also connected to circuit 618, and establishes, the three operational modes as explained earlier, namely—In the paused (shut down) state voltage is not supplied neither to circuit 618 nor to assembly 612. In the activated state, in case that motion sensing assembly 622 issues an indication of a movement, voltage applied. The voltage of dry cell 624 is then multiplied by a voltage multiplying circuit 629 (for example—three fold) and is applied to logic circuit 630.

In case the sensors array 616 issues indication designating a “Night” time condition, in which it is necessary to dim and darken the mirror (under a blinding condition), voltage would be applied to signals generator 632. In case an indication of the existence of “day” conditions is given, or even of the “Night” time condition but without the need of dimming the mirror, voltage would mot be applied to signals generator 632.

Let's refer now to FIGS. 6b-6d. These figures constitutes an illustration of an add-on automatic (self) dimming liquid crystal mirror 610 in accordance with the invention, wherein it is mountable as an add-on unit on the original mirror that is found in the vehicle (and is not illustrated).

As can be seen in the figures, mirror 610 comprises harnessing means 711 that includes in tandem springy means 712 and clasping means 714 used (together) to harness the mirror unto the original, existing vehicle's mirror.

An additional aspect that can be discerned in the mirror is that the liquid crystal constituting a part of liquid crystal cell digital mirror 610 has a pigmentation that imparts a highly visible color to the mirror.

It is to be noted that mirror 610, that constitutes an add on (rear view) mirror for a vehicle and characterized by its auto dimming capability, does not need to be supplied by electricity from the vehicle's system, but rather is essentially autonomous from the electricity supply aspect of its requirements and does not need to be supplied 1 by the vehicle's electricity system (thus does not need to be connected to it). This, and moreover, mirror 610 is also characterized by its improved mounting mechanism (as explained inhere above) that ensures damping of the vibrations thus providing a stable image during the voyage—combined with increased safety due to its fastening mechanism. Hence it is less susceptible to the possibility of mirror 610 being cast (torn) away from the exiting original mirror on which it is mounted, when the vehicle is in motion and especially in case of an accident. To top it all, mirror 610—has a prominent bright colorful pigmentation (as per the color established by that of the liquid crystal that is implemented in the auto dimming mechanism).

Referring to FIG. 6e. The figure constitutes an additional schematic illustration of a circuitry applicable to be implemented in mirrors such as mirror 610 (see FIG. 6b-6d). The electrical circuitry 810 is operable by lithium dry cell battery (of the CR 2450 type). Two such batteries 815 and 816 are arranged in a row producing a voltage of 4-6.6 volt for operating the mirror. Off/Auto slide switch 818 is a mechanical switch connected to battery 816 and controls the power to the mirror. In a ON state of switch 818, the circuitry micro controller 820 is switched into AUTO state and the mirror is operable in accordance with front and rear sensors 822 and 824 that sense the light level in two directions (such sensors can be photo resistors which change their resistance in accordance with the light level and therefore serving as glare indicators). Micro controller 820 supplies power to the sensors via one of its exits 826 and in order to save power, the supply is preformed before the A/D reading by the controller has taken place. Micro controller 820 could be microchip of the 12F684 type containing A/D transformers for reading the light level. Micro controller 820 controls the mirror operation in accordance with the sensors inputs and the operation switches. Micro controller 820 is equipped with appropriate software for this purpose. Override button 828 enables the transferring of the mirror to an ON state in accordance with the operator (e.g.—the driver) decision. Switching the button to an ON position will transfer the mirror to an ON state for a pre-set period of time (for example—two hours). Such capability enables the driver to be glare defended on his will. Pushing the switch will cause the mirror to move into a CLEAR state for a short period of time (e.g. 30 seconds) or till additional switch change will take place. At the end of such time period, the mirror will be switched back to an AUTO state. Exits 830 and 832 control the mirror state. When no change in mirror reflection is needed, exists 830 and 832 are at high resistance state and no signal is transferred to the mirror. At this stage, the circuit power consumption is basically the controller. In case a dimming demanding situation occurs, exits 830, 832, provides a signal (for example—square type at 50-500 Hz and at different phase one to the other). From then, the signal proceed to gates 834 and 836 that switch the batteries power into entries 838 and 839 for establishing the mirror-operating signal (squared signal equal to the battery voltage). In a filed experiment such circuitry provides for 3 years operation of a 5 to 10 inches dimming mirror that is activated for reflection changes demands up to two hours a day (while the micro controller is operated an additional two hours a day). Any professional in the filed will understand that in such a mirror the movement detection array will switch the mirror into an OFF state upon not detecting of movements for certain period of time even if the light sensors will continue to provide glare occurrence indications (in order to avoid mirror operating while the car is parking and the mirror is exposed to passing vehicle lights etc.)

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An automatic dimming mirror system, comprising a liquid crystal reflective assembly being responsive to a voltage applied across the liquid crystal reflective assembly, and an electronic circuitry for varying a level of said the voltage at a predetermined rate thereby to alter a reflectance level of the liquid crystal reflective assembly at the predetermined rate.

2. The system of claim 1, wherein said electronic circuitry is designed and configured to receive ambient light information and rear light information, and to select said level of said voltage and said predetermined rate based on said ambient light information, said rear light information or a combination of said ambient light information and said rear light information.

3. The system of claim 2, further comprising an ambient light sensor for collecting and transmitting said ambient light information to said electronic circuitry, and a rear light sensor for collecting and transmitting said rear light information to said electronic circuitry.

4. The system of claim 2, wherein said ambient light information and said rear light information each independently comprises light illuminance information.

5. The system of claim 2, wherein said ambient light information and said rear light information each independently comprises light brightness information.

6. The system of claim 2, wherein said ambient light information and said rear light information each independently comprises light spectral information.

7. The system of claim 2, further comprising a user interface communicating with said electronic circuitry.

8. The system of claim 7, wherein said electronic circuitry is designed and configured to receive from said user interface a characteristic response information of a user to light and to weight said predetermined rate based on said characteristic response information.

9. The system of claim 2, wherein said predetermined rate is selected from a set of discrete rates, each rate of said set of discrete rates corresponding to a different ambient light condition.

10. The system of claim 9, wherein each rate of said set of discrete rates corresponds to a different illuminance range of said ambient light and/or said rear light.

11. The system of claim 9, wherein each rate of said set of discrete rates corresponds to a different brightness range of said ambient light and/or said rear light.

12. The system of claim 9, wherein each rate of said set of discrete rates corresponds to a different predominant wavelength range of said ambient light and/or said rear light.

13. The system of claim 2, wherein said predetermined rate is a monotonic decreasing function of an illuminance of said ambient light and/or said rear light.

14. The system of claim 2, wherein said predetermined rate is a monotonic decreasing function of a brightness of said ambient light and/or said rear light.

15. The system of claim 2, wherein said predetermined rate is a non-monotonic function of a predominant wavelength of said ambient light and/or said rear light.

16. The system of claim 2, wherein said electronic circuitry is designed and configured to vary said level of said voltage at a continuous or step-wise varying rate.

17. The system of claim 1, serving as a rearview mirror of a vehicle.

18. The system of claim 1, serving as an interior rearview mirror of a vehicle.

19. The system of claim 1, serving as an exterior rearview mirror of a vehicle.

20. A method of dimming light reflected from a mirror, the method comprising applying a variable level voltage across a liquid crystal reflective assembly so as to alter a reflectance level of said liquid crystal reflective assembly, wherein said variable level voltage is varied at a predetermined rate.

21. The method of claim 20, further comprising receiving ambient light information and rear light information, and selecting said level of said voltage and said predetermined rate based on said ambient light information, said rear light information or a combination of said ambient light information and said rear light information.

22. The method of claim 21, further comprising sensing said ambient light information using an ambient light sensor, and sensing said rear light information using a rear light sensor.

23. The method of claim 21, wherein said ambient light information and said rear light information each independently comprises light illuminance information.

24. The method of claim 21, wherein said ambient light information and said rear light information each independently comprises light brightness information.

25. The method of claim 21, wherein said ambient light information and said rear light information each independently comprises light spectral information.

26. The method of claim 20, further comprising receiving a characteristic response information of a user to light and weighting said predetermined rate based on said characteristic response information.

27. The method of claim 21, wherein said predetermined rate is selected from a set of discrete rates, each rate of said set of discrete rates corresponding to a different ambient light condition.

28. The method of claim 27, wherein each rate of said set of discrete rates corresponds to a different illuminance range of said ambient light and/or said rear light.

29. The method of claim 27, wherein each rate of said set of discrete rates corresponds to a different brightness range of said ambient light and/or said rear light.

30. The method of claim 27, wherein each rate of said set of discrete rates corresponds to a different predominant wavelength range of said ambient light and/or said rear light.

31. The method of claim 21, wherein said predetermined rate is a monotonic decreasing function of an illuminance of said ambient light and/or said rear light.

32. The method of claim 21, wherein said predetermined rate is a monotonic decreasing function of a brightness of said ambient light and/or said rear light.

33. The method of claim 21, wherein said predetermined rate is a non-monotonic function of a predominant wavelength of said ambient light and/or said rear light.

34. The method of claim 21, wherein said application of said variable level voltage across said liquid crystal reflective assembly is done at a continuous or step-wise varying rate.

35. A vehicle having an automatic dimming mirror system, the automatic dimming mirror system comprising a liquid crystal reflective assembly being responsive to a voltage applied across the liquid crystal reflective assembly, and an electronic circuitry for varying a level of the voltage at a predetermined rate thereby to alter a reflectance level of the liquid crystal reflective assembly at the predetermined rate.

36. The vehicle of claim 35, wherein said automatic dimming mirror system electronic circuitry is designed and configured to receive ambient light information and rear light information, and to select said level of said voltage and said predetermined rate based on said ambient light information, said rear light information or a combination of said ambient light information and said rear light information.

37. The vehicle of claim 36, wherein said automatic dimming mirror system further comprises an ambient light sensor for collecting and transmitting said ambient light information to said electronic circuitry, and a rear light sensor for collecting and transmitting said rear light information to said electronic circuitry.

38. The vehicle of claim 36, wherein said ambient light information and said rear light information each independently comprises light illuminance information.

39. The vehicle of claim 36, wherein said ambient light information and said rear light information each independently comprises light brightness information.

40. The vehicle of claim 36, wherein said ambient light information and said rear light information each independently comprises light spectral information.

41. The vehicle of claim 36, wherein said automatic dimming mirror system further comprises a user interface communicating with said electronic circuitry.

42. The vehicle of claim 41, wherein said electronic circuitry is designed and configured to receive from said user interface a characteristic response information of a user to light and to weight said predetermined rate based on said characteristic response information.

43. The vehicle of claim 36, wherein said predetermined rate is selected from a set of discrete rates, each rate of said set of discrete rates corresponding to a different ambient light condition.

44. The vehicle of claim 43, wherein each rate of said set of discrete rates corresponds to a different illuminance range of said ambient light and/or said rear light.

45. The vehicle of claim 43, wherein each rate of said set of discrete rates corresponds to a different brightness range of said ambient light and/or said rear light.

46. The vehicle of claim 43, wherein each rate of said set of discrete rates corresponds to a different predominant wavelength range of said ambient light and/or said rear light.

47. The vehicle of claim 36, wherein said predetermined rate is a monotonic decreasing function of an illuminance of said ambient light and/or said rear light.

48. The vehicle of claim 36, wherein said predetermined rate is a monotonic decreasing function of a brightness of said ambient light and/or said rear light.

49. The vehicle of claim 36, wherein said predetermined rate is a non-monotonic function of a predominant wavelength of said ambient light and/or said rear light.

50. The vehicle of claim 36, wherein said electronic circuitry is designed and configured to vary said level of said voltage at a continuous or step-wise varying rate.

51. The vehicle of claim 35, wherein said automatic dimming mirror system is an interior rearview mirror of the vehicle.

52. The vehicle of claim 35, wherein said automatic dimming mirror system is an exterior rearview mirror of the vehicle.

53. An automatic dimming mirror system of claim 1, wherein said system comprises in addition—
a selector switch that sorts operating states, linked to said circuitry and establishing a mode for activating said assembly and wherein said mirror is characterized by that that it comprises in addition—
a movement sensing array that is connectable to said circuitry, and
a dry cell battery that is connectable to said movement sensing array and to said circuitry, and
whereas said switch renders the person using said mirror a possibility to fix three different operating states—pause state, activating state to a maximal dimming (darkening) level of said mirror system and an automatic state in which said darkness level of said mirror system is set upon movement indication from said movement sensors array.

54. An automatic dimming mirror system of claim 53, wherein—
said sensors array includes two sensors for sensing levels of illumination prevailing in two directions and fixing a value of a level for dimming said mirror in accordance with said detected levels.

55. An automatic dimming mirror system of claim 53, wherein—
said movement sensing array—
provides indications as to the absence of movement in order to transfer said mirror circuitry to the paused state after a pre set time interval during which said movement sensing array did not sense any movement as elapsed, and
provides indications relating to movements in order to switch over said mirror circuitry to said automatic state in which said level of dimming of said mirror is fixed by said sensors array.

56. An automatic dimming mirror of claim 53, wherein—
said mirror comprises harnessing means in order to mount it as an add-on unit upon already existing vehicle's mirror.

57. An automatic dimming mirror in accordance with claim 56, wherein said harnessing means comprises—
a springy means and
an adjustable clasping means
for harnessing said mirror to said existing vehicle's mirror.

58. An automatic dimming mirror in accordance with claim 53, wherein—
said mirror is characterized, in addition, by that said liquid crystal reflective assembly has a pigmentation that imparts on it a prominent bright colorful hue.
